(19) United States
(12) Patent Application Publication
(10) Pub. No.: US 2025/0131068 A1
(43) Pub. Date: Apr. 24, 2025

(54) PERMISSIONED ENCRYPTED AND REDUNDANT MEDIA ACCESS FILE DISTRIBUTION SYSTEM

(71) Applicant: Nothing Rhymes With Entertainment, LLC, Los Angeles, CA (US)

(72) Inventor: Heath Clinton Michaels, Los Angeles, CA (US)

(21) Appl. No.: 18/905,557

(22) Filed: Oct. 3, 2024

Related U.S. Application Data
(60) Provisional application No. 63/591,641, filed on Oct. 19, 2023.

(51) Int. Cl. G06F 21/10; G06F 21/60

(52) U.S. Cl. CPC G06F 21/1014; G06F 21/602

(57) ABSTRACT

A system for providing a permissioned encrypted and redundant media access file distribution system. The system manages, by a first node, the digital content and metadata associated with the digital content, where the digital content is decentralized. The system further enables, by a second node, access to the digital content by an authorized user, where the authorized user purchased the digital content. The system further manages, by a third node, cryptographic keys that are used to encrypt and decrypt digital content, where the first node secures the digital content for access by the authorized user by receiving and disseminating chunks of the associated files.

### CROSS-REFERENCE TO RELATED APPLICATION

The present disclosure claims the benefit of priority of co-pending U.S. Provisional Patent Application No. 63/591,641, filed on Oct. 19, 2023, and entitled “PERMISSIONED ENCRYPTED AND REDUNDANT MEDIA ACCESS FILE DISTRIBUTION SYSTEM,” the contents of which are incorporated in full by reference herein.

### INTRODUCTION

The present disclosure relates generally to file distribution systems and more particularly to a permissioned encrypted and redundant media access file distribution system.

Conventionally, consumers purchase digital assets, but do not actually own the digital assets. Copyright holders, and others, maintain rights over much of the digital content that consumers mistakenly believe that they have purchased. This leads to confusion and frustration for the consumer. With the advent of the metaverse and other digital domains, there are many transactions occurring on a daily basis where purchasers believe that they have bought something and now own such items, either in the digital world or the real world. However, many people are dismayed to find that they are essentially borrowing those items that they paid for, which causes confusion, arguments, and resentment.

There are currently a variety of distributed systems, such as, for example, peer to peer (blockchain) technologies that have attempted to deal with this issue, but these techniques do not work in all aspects. Nor have all the possible applications been explored. Distributed systems for music and other media are not secure, thereby not acceptable to most owners of rights.

The present introduction is provided as background context only and is not intended to be limiting in any manner. It will be readily apparent to those of ordinary skill in the art that the concepts and principles of the present disclosure may be implemented in other applications and contexts equally.

### SUMMARY

The present disclosure relates to a system for providing a permissioned encrypted and redundant media access file distribution system. As described in more detail herein, embodiments provide a permissioned encrypted and redundant media access file distribution system that overcomes the limitations of the prior art.

In one illustrative embodiment, the present disclosure provides a system including one or more processors, and logic encoded in one or more non-transitory computer-readable storage media for execution by the one or more processors. The logic when executed is operable to cause the one or more processors to perform operations including: managing, by a first node, the digital content and metadata associated with the digital content, where the digital content is decentralized; enabling, by a second node, access to the digital content by an authorized user, where the authorized user purchased the digital content; and managing, by a third node, cryptographic keys that are used to encrypt and decrypt digital content, where the first node secures the digital content for access by the authorized user. Optionally, in some embodiments, the logic when executed is further operable to cause the one or more processors to perform operations including: encrypting the digital content; chunking the digital content; and scattering the digital content. In some embodiments, ownership of the digital content is immutable. In some embodiments, the logic when executed is further operable to cause the one or more processors to perform operations including enabling the digital content to be temporarily transferred from the authorized user to a temporary user. In some embodiments, the logic when executed is further operable to cause the one or more processors to perform operations including securing communication among the first node, the second node, and the third node. In some embodiments, the logic when executed is further operable to cause the one or more processors to perform operations including coupling physical goods with digital non-fungible tokens using tamper-evident near-field communication tags. In some embodiments, one or more master encryption keys are derived from secret inputs, and where the one or more master encryption key decrypts one or more cryptographic keys.

In a further illustrative embodiment, the present disclosure provides a computer-implemented method for providing a permissioned encrypted and redundant media access file distribution system. The method includes: managing, by a first node, the digital content and metadata associated with the digital content, where the digital content is decentralized; enabling, by a second node, access to the digital content by an authorized user, where the authorized user purchased the digital content; and managing, by a third node, cryptographic keys that are used to encrypt and decrypt digital content, where the first node secures the digital content for access by the authorized user. Optionally, in some embodiments, the method further includes: encrypting the digital content; chunking the digital content; and scattering the digital content. In some embodiments, ownership of the digital content is immutable. In some embodiments, the method further includes enabling the digital content to be temporarily transferred from the authorized user to a temporary user. In some embodiments, the method further includes including securing communication among the first node, the second node, and the third node. In some embodiments, the method further includes coupling physical goods with digital non-fungible tokens using tamper-evident near-field communication tags. In some embodiments, one or more master encryption keys are derived from secret inputs, and where the one or more master encryption key decrypts one or more cryptographic keys.

In another illustrative embodiment, the present disclosure provides a non-transitory computer-readable storage medium with program instructions stored thereon. The program instructions when executed by one or more processors are operable to cause the one or more processors to perform operations including: managing, by a first node, the digital content and metadata associated with the digital content, where the digital content is decentralized; enabling, by a second node, access to the digital content by an authorized user, where the authorized user purchased the digital content; and managing, by a third node, cryptographic keys that are used to encrypt and decrypt digital content, where the first node secures the digital content for access by the authorized user. Optionally, in some embodiments, the program instructions when executed by one or more processors are operable to cause the one or more processors to perform operations including: encrypting the digital content; chunking the digital content; and scattering the digital content. In some embodiments, ownership of the digital content is immutable. In some embodiments, the instructions when executed are further operable to cause the one or more processors to perform operations including enabling the digital content to be temporarily transferred from the authorized user to a temporary user. In some embodiments, the instructions when executed are further operable to cause the one or more processors to perform operations including securing communication among the first node, the second node, and the third node. In some embodiments, the instructions when executed are further operable to cause the one or more processors to perform operations including coupling physical goods with digital non-fungible tokens using tamper-evident near-field communication tags.

### BRIEF DESCRIPTION OF THE DRAWINGS

The present disclosure is illustrated and described with reference to the various drawings, in which like reference numbers are used to denote like system components and/or method steps, as appropriate.

FIG. 1 is a block diagram of an example environment for providing a permissioned encrypted and redundant media access file distribution system with decentralized storage.

FIG. 2 is a flow chart for providing a permissioned encrypted and redundant media access file distribution system.

FIG. 3 is a block diagram of an example environment, including a media aggregate storage (MAST) node and associated flow in relation to layers of the MAST node and to key and encryption management (KEM) nodes.

FIG. 4 is a block diagram of an example environment, including a validation and access (VALAC) node and associated flow in relation to layers of the VALAC node and to a KEM node.

FIG. 5 is a block diagram of an example environment, including a KEM node and associated flow in relation to layers of the KEM node, to a MAST node, and to VALAC nodes.

FIG. 6 is a flow chart for providing content ingestion.

FIG. 7 is a flow chart for providing content access.

FIG. 8 is a block diagram of an example environment including a permissioned encrypted and redundant media access file distribution system with decentralized storage, and involving creation of permissioned encrypted and redundant media access (PERMA) entry.

FIG. 9 is a block diagram of an example environment including a permissioned encrypted and redundant media access file distribution system with decentralized storage, and involving a point of sale.

FIG. 10 is a block diagram of an example environment including a permissioned encrypted and redundant media access file distribution system with decentralized storage, and involving verification of delivery.

FIG. 11 is a block diagram of an example network environment of the present disclosure.

FIG. 12 is a block diagram of an example computing system of the present disclosure.

### DETAILED DESCRIPTION

Embodiments described herein provide a permissioned encrypted and redundant media access file distribution system. The permissioned encrypted and redundant media access system is a comprehensive, secure, and efficient system for distributing and owning digital files. Its unique application of digital ownership rights, coupled with its added utility of digital authentication for physical goods, provides a robust and adaptable platform for various applications in the digital and physical goods space.

In the digital age, the concept of ownership is undergoing a transformation, especially in the domain of digital purchases. Unlike physical media, digital content often comes with strings attached, challenging the traditional understanding of ownership rights. For instance, purchasing a digital movie or a music album often means buying a limited-use license rather than outright ownership of the purchased item. This shift has significant implications for consumers, limiting their ability to resell, lend, or transfer their digital purchases in the same way they would with physical media. Furthermore, intellectual property (IP) owners can modify or delete purchases without the owner's permission.

Consequently, the concept of digital media ownership is marred by uncertainties. Unlike tangible media, digital content often comes with one-sided restrictions, leading to a precarious sense of ownership for consumers. High-profile cases of digital content revocation illustrate the pressing need for a reliable digital ownership model, as current legal and market solutions inadequately protect consumer rights, tipping the balance unfavorably in intellectual property (IP) owners' direction.

The heart of this problem lies in the scope of the First Sale Doctrine, a legal principle that allows the purchaser of a physical copy of a copyrighted work to resell, lend, or otherwise dispose of it as they see fit without requiring permission from the copyright holder. Similar legal concepts exist in many countries, often under different names. However, this doctrine has not yet been extended to cover digital purchases, leaving consumers unprotected in the digital space. Imagine buying a physical book, only to have the publisher show up at your door one day and demand you return it or alter its contents. That would be unthinkable. Yet, in the digital domain, it is a reality consumers face.

As our lives become increasingly digital, the importance of true ownership over our digital purchases grows. From e-books and movies to comics and video games, these digital assets play a central role in our daily experiences and shape our cultural landscape. Without clear and enforceable ownership rights, consumers are left vulnerable to the whims of IP owners, eroding trust in the digital marketplace. Conversely, the alternative solutions found in platforms such as BitTorrent and decentralized storage like IPFS tilt the playing field too far in the other direction, offering open access to intellectual property with no protection for the IP owners.

As described in more detail herein, embodiments addresses these concerns by offering a system where digital ownership mirrors the rights and permanence traditionally associated with physical media. Leveraging blockchain technology, distributed P2P storage, and advanced encryption, embodiments ensure that once a digital item is purchased, it remains the indisputable property of the buyer, impervious to post-sale revocation or alteration. This approach not only empowers consumers but also respects the integrity of ownership as outlined in the First Sale Doctrine. Furthermore, to maintain content integrity and legality, embodiments operate on a curated model, with stringent vetting during the content ingestion process. This removes the need for moderation allowing for the true immutability of digital purchases.

Embodiments described herein provide a decentralized platform that leverages blockchain, peer-to-peer protocols, and advanced encryption into a novel solution that establishes true ownership of digital purchases. The system securely stores digital media on its platform and ensures consumers have permanent access to their purchases. This provides consumers with the same ownership rights that consumers have come to expect from buying physical media. This is achieved by limiting the control IP owners have over secondary sales and the deletion of purchases from consumers' digital libraries. As a result, the system restores trust in the digital marketplace by giving the consumer confidence that their purchases are truly owned and cannot be revoked or altered. This approach balances the interests of consumers with those of the IP owners.

The entire system is devised to ensure digital purchases remain the buyer's property without the risk of revocation by the IP owner, while also preventing unauthorized copying and distribution.

In various embodiments, the system uses blockchain to track inventory and ensure scarcity akin to physical purchases. Every purchase and transfer are tracked using a unique non-fungible token assigned to the buyer. This token represents the purchased item, whether that's a movie, etc. Where it goes, the ownership goes. All content in the PERMA system is encrypted, chunked (broken apart into smaller pieces), and stored across a decentralized, low-latency network. When the single owner in possession of a token wants to access their content, it is reassembled, decrypted, and securely delivered to them.

In various embodiments, the PERMA platform is not open access, meaning that content ingested into the system is curated. As such, there's no need for moderation after-the-fact. In various embodiments, the only way to put content onto the PERMA platform is through heavily vetting. As such, the PERMA platform provides a truly one-of-a-kind ownership experience where all purchases are immutable and final. The PERMA platform is only platform that is decentralized and offers transferrable purchases.

As described in more detail herein, embodiments provide a layered architecture having inter-node communication and interoperability among nodes or layers of the system. Embodiments also provide key management and sharding or scattering of digital content on of the nodes or layers. Furthermore, some embodiments are associated with replication of the First Sale Doctrine, which is achievable through immutable ownership. Embodiments also provide a buyback option as an alternative to Digital Millennium Copyright Act (DMCA) takedowns.

In the following description, certain terminology is used to describe certain features of one or more embodiments of the invention. The term “nodes” refers to one or more computing devices capable of processing digital entities in the system. In the context of blockchain or similar distributed networks, a node may exchange information peer-to-peer, maintains consensus, validates the ledger, verifies transactions, stores and propagates data, thereby ensuring the system's integrity and security. Nodes may be used for file distribution, decentralized apps, and financial transactions within the system.

As described in more detail herein, in association with providing a permissioned encrypted and redundant media access file distribution, a system manages, by a first node, the digital content and metadata associated with the digital content, where the digital content is decentralized. The system further enables, by a second node, access to the digital content by the authorized user, where the authorized user purchased the digital content. The system further manages, by a third node, cryptographic keys that are used to encrypt and decrypt digital content. The first node secures the digital content for access by an authorized user.

The system's technology has a wide range of applications across various types of digital files and modes of consumption. For example, in various applications, embodiments enable e-books to be purchased, owned, and transferred just like physical books, with readers being the verifiable owners. Similarly, in various applications, embodiments enable music files to purchased and owned outright, bringing back the tangibility of album ownership in the digital music space. In various applications, the system also manages digital assets such as digital artworks, 3D models for games or simulations, software applications, and proprietary datasets. The system is adaptable and may accommodate any digital data file that can be streamed or transmitted in a sequence of bits, enabling a truly diverse digital marketplace.

As described in more detail herein, in various embodiments, the system's functionality revolves around transforming digital files into secure, encrypted entities, which are then chunked and distributed across a decentralized network of nodes. This distribution not only ensures the security and confidentiality of the digital files but also provides redundancy.

Various embodiments of the system broaden the scope of what may be considered a digital commodity. The system securely and efficiently distributes any digital data file that can be streamed or transmitted in a sequence of bits, or a combination thereof. For instance, the system may enable the distribution of a custom artificial intelligence (AI) model and/or a language model that imitates the individual's unique writing style, and distribute writing through the platform, thus encouraging a vibrant marketplace for personalized AI models, for example.

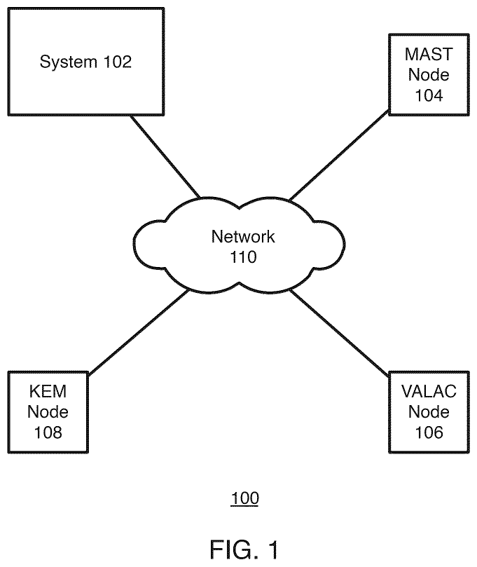

FIG. 1 is a block diagram of an example environment 100 for providing a permissioned encrypted and redundant media access file distribution system with decentralized storage. As shown, the environment 100 includes a system 102, a media aggregate storage (MAST) node 104 that may be part of the system 102, a validation and access (VALAC) node 106 that may be part of the system 102, and a key and encryption management (KEM) node 108 that may be part of the system 102. These nodes 104, 106, and 108 are the core of the architecture of the permissioned encrypted and redundant media access (PERMA) file distribution platform and system 102. As described herein, the MAST node 104, the VALAC node 106, and the KEM node 108 and their internal layers collaborate to maintain the system's operations. The internal layers of these nodes are described in more detail below.

In various embodiments the environment 100 represents the PERMA file distribution platform. In various embodiments, the system 102 controls operations of the PERMA file distribution platform.

For ease of illustration, the system 102 is shown separately from the MAST node 104, the VALAC node 106, and the KEM node 108. In some embodiments, the system 102 may contain the MAST node 104, the VALAC node 106, and the KEM node 108. As such, in various embodiments described herein, the terms system 102, the system, the PERMA file distribution platform, and the platform may be used interchangeably.

While the system 102 is described as performing implementations described herein, in various implementations, any suitable component or combination of components associated with system 102 such as the MAST node 104, the VALAC node 106, and the KEM node 108, and their respective layers, or any suitable processor or processors associated with system 102 may facilitate performing the implementations described herein in association with the PERMA file distribution platform.

As described in more detail herein, the MAST node 104 functions to provide handling of the storage, metadata, decryption, and dissemination of digital media content. The VALAC node 106 functions to provide user authentication, access control, payment processing, and financial transactions. The KEM node 108 functions to provide cryptographic key management and encryption during a content ingestion phase.

In various embodiments, the MAST node 104 and the VALAC node 106 are public nodes. As described in more detail herein, in various embodiments, these public nodes 104 and 106 may be accessed and operated by anyone with the proper computer or server specs to operate the node effectively. Also, these public nodes 104 and 106 work together to ensure efficient content handling, secure user access, and seamless transactions within the system platform.

The KEM node 108 is a private node without public access. The KEM node 108 is also referred to as a trusted node. As described in more detail herein, in various embodiments, this trusted node is operated only by specially authorized entities. For example, trusted nodes are restricted to entities that have undergone a comprehensive vetting process, such as reputable non-profit organizations or technological consortia. These trusted nodes also require advanced hardware security, such as hardware security modules (HSMs) and trusted execution environments (TEEs), to ensure the protection of sensitive operations.

Trusted nodes such as the KEM node 108 ensures a higher level of trust and security in key management and encryption processes. The system's use of a trusted node, as opposed to a public approach, ensures the highest level of security for the critical cryptographic operations performed by these layers. By restricting the KEM node 108 operation to vetted entities, the system 102 maintains strict control over key generation, management, and encryption processes, mitigating potential risks associated with a decentralized key management system.

As described in more detail herein, an important aspect of the system 102 is the inter-node communication among the MAST node 104, the VALAC node 106, and the KEM node 108. Such inter-node communication ensures the synchronized functioning of the platform, allowing for secure interaction between content distribution and access control mechanisms.

In various embodiments, the architecture of the PERMA platform is designed as a multi-layered system. Each layer serves a distinct purpose in creating the entirety of the decentralized platform for secure digital media distribution. Example embodiments directed to the layers of the MAST node 104, the VALAC node 106, and the KEM node 108 are described in more detail herein. How the layers are structured and fit within the node structure of the system 102 is also described in more detail herein.

For ease of illustration, FIG. 1 shows one block for each of the system 102, the MAST node 104, the VALAC node 106, and the KEM node 108. Blocks 102, 104, 106, and 108 may represent multiple systems, MAST nodes, VALAC nodes, and KEM nodes. In other implementations, environment 100 may not have all of the components or elements shown and/or may have other elements including other types of elements instead of, or in addition to, those shown herein.

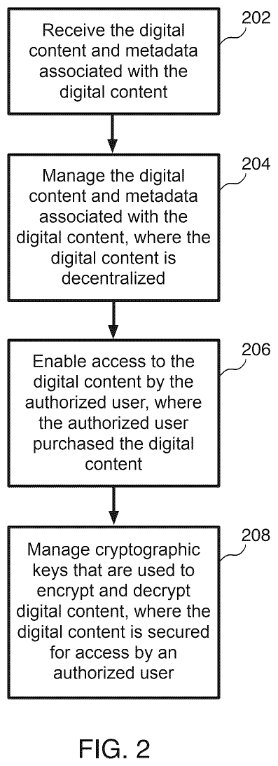

FIG. 2 is a flow chart for providing a permissioned encrypted and redundant media access file distribution system. Referring to both FIGS. 1 and 2, a method is initiated at block 202, where a system such as the system 102 receives digital content and metadata associated with the digital content. The digital content may be a digital movie for example. The digital content (e.g., digital files) and associated information or metadata associated with the digital content are permissioned or curated, with some moderation at the point of ingestion. In various embodiments, the admin tool ensures that compliant material is added to the system 102. In various embodiments, the relevant metadata may include a title, a description, a genre, the cast, crew information, inventory, a price, etc. Such metadata may be used to help categorize and identify the digital content within the ecosystem associated with the system 102.

At block 204, where the system 102 manages, by the MAST node 104, the digital content and metadata associated with the digital content. In various embodiments, the digital content is decentralized. As described in more detail herein, in various embodiments, the MAST node 104 decrypts the digital content within its delivery layer at the time of digital content access. The MAST node 104 then scatters the digital content. The MAST node 104 stores the digital content across a decentralized, low-latency network.

In various embodiments, the MAST node 104 prevents unauthorized copying and distribution of the digital content by decentralizing the digital content. In various embodiments, while the scattering of the digital content is performed within the MAST node 104, the encryption and chunking of content, as well as the encryption and decryption of the associated keys are managed separately within KEM node 108. The system 102 uses secure enclaves, such as TEEs, for key reassembly as well as decryption. In various embodiments, access to the MAST node 104 and thereby the digital content is available to the public. Example embodiments directed to the operations of the MAST node 104 and its layers are described in more detail below.

At block 206, the system 102 enables, by the VALAC node 106, access to the digital content by the authorized user. In various embodiments, the authorized user purchased the digital content, where the authorized user purchased sole ownership of the digital content, with transferability in line with the First Sale Doctrine.

In various embodiments, ownership of the digital content is immutable. As described in more detail herein, the ownership of the digital content is immutable and cannot be revoked. The immutability of ownership is enabled in part by the VALAC node 106 maintaining centralized control of access of the digital content.

The system 102 provides immutable ownership via smart contracts. As described in more detail herein, each digital content item is tied to a non-fungible token (NFT), with ownership and access rules enforced by smart contracts on the Ethereum blockchain. This ensures that once a digital item is purchased, the ownership cannot be altered or revoked by the IP owner. More specifically, access to the immutable digital item within the PERMA platform cannot be revoked.

In various embodiments, as a part of the system enabling access to the digital content, the VALAC node 106 of the system plays a gatekeeping function in that the second node tracks who owns the digital content based on one or more considerations (e.g., payment considerations). In various embodiments, when an authorized user in possession of an NFT wants to access their digital content, the VALAC node 106 provides verification and access (as well as wallet management, purchasing, etc.). The MAST node 104 reassembles the digital content, the digital content decrypts the digital content, and securely delivers the digital content to the authorized user. In various embodiments, access to the VALAC node 106 and thereby the digital content is available to the public. Example embodiments directed to the operations of the VALAC node 106 and its layers are described in more detail below.

At block 208, the system 102 manages, by the KEM node 108, cryptographic keys that are used to encrypt and decrypt digital content. In various embodiments, the KEM node 108 secures the digital content for access by an authorized user. In various embodiments, as a part of the system managing the cryptographic keys, the VALAC node 108 of the system plays a supervisory function in that the KEM node 108 of the system creates the cryptographic keys, stores cryptographic keys, and distributes the cryptographic keys. In various embodiments, the KEM node 108 is private. The VALAC node 106 assigns an NFT to the buyer who purchased the digital content, and the NFT remains in possession of the buyer.

In various embodiments, the system 102 provides a smart contract rental and lending system. The system 102 enables the digital content to be temporarily transferred from the authorized user to a temporary user. For example, the system 102 enables users to commit their owned digital content items for profit-sharing rentals using smart contracts on-chain to facilitate a pay-share rental model, as well as a lending system allowing users to lend out their owned item for a set period of time.

During a rental or lending period, ownership is transferred temporarily and managed on-chain. Content can only be accessed by one user per token at a time. This means that the original purchaser cannot access the digital content while it is being rented or borrowed. Once the rental or lending period ends, ownership reverts to the original purchaser, who can then access the content again, locking out the renter or borrower. Example embodiments directed to the operations of the KEM node 108 and its layers are described in more detail herein.

Although the steps, operations, or computations may be presented in a specific order, the order may be changed in particular embodiments. Other orderings of the steps are possible, depending on the particular implementation. In some particular embodiments, multiple steps shown as sequential in this specification may be performed at the same time. Also, some embodiments may not have all of the steps shown and/or may have other steps instead of, or in addition to, those shown below.

The following describes inter-node communication among the MAST node 104, the VALAC node 106, and the KEM node 108. In various embodiments, the system 102 secures communication among the nodes. For example, in some embodiments, the system 102 secures communication between the MAST node 104 and the KEM node 108. The system 102 also secures communication between the VALAC node 106 and the KEM node 108. In other embodiments, the system 102 secures communication between the VALAC node 106 and the MAST node 104.

In various embodiments, the system 102 provides inter-node interactions to replicate First Sale Doctrine. For example, the VALAC node 106 validates NFT ownership to confirm legitimate purchases. The VALAC node 106 also enforces access rules, preventing IP owners from revoking access. The MAST node 104 securely retrieves and reassembles encrypted content chunks. The MAST node 104 also provides decentralized storage to ensure content availability and remains tamper-proof. The KEM node 108 generates and manages encryption keys for the digital content, tied to NFT ownership. The KEM node 108 also reassembles keys in TEEs for secure content decryption. In various embodiments, the system 102 provides secure communication between an Ethereum virtual machine (EVM) layer of the VALAC node 106 and the key management layer of the KEM node 108 for content access authorization.

As described in more detail herein, the core architecture of the system necessitates secure, efficient communication protocols between the nodes to facilitate digital content access and distribution. For example, in various embodiments, a delivery layer of the MAST node 104 collaborates closely with a key management layer of the KEM node 108 to deliver keys securely to this layer. In various embodiments, after user authorization, an EVM layer of the VALAC node 106 communicates with the KEM node 108 to initiate on-demand reconstitution of keys, enabling the secure decryption and delivery of content. In various embodiments, after authentication, a key management layer of the KEM node 108 receives authorization from the EVM layer of the VALAC node 106, giving the KEM node 108 the go ahead to reconstitute the keys to send to the delivery layer of the MAST node 104.

In various embodiments, the system 102 employs advanced protocols to facilitate secure and efficient communication between each node. Such protocols may include RESTful application programming interfaces (APIs), WebSockets for real-time data transfer, and end-to-end encryption to protect data integrity and confidentiality during transmission. In various embodiments, each node in operation is responsible for handling its own unique public/private key pair for secure communication and verification.

In various embodiments, to mitigate potential security risks, the communication protocol includes features such as mutual transport layer security (TLS) authentication, encrypted data payloads, and regular security audits. These measures safeguard against unauthorized access and data breaches.

In various embodiments, for monitoring and incident responses, the system 102 employs an ever-changing, comprehensive monitoring system that detect anomalies and potential security breaches in real-time, including an incident response plan in place to promptly address and resolve any security incidents.

Example embodiments directed to the inter-node communication among the MAST node 104, the VALAC node 106, and the KEM node 108 and their respective layers are described in more detail below.

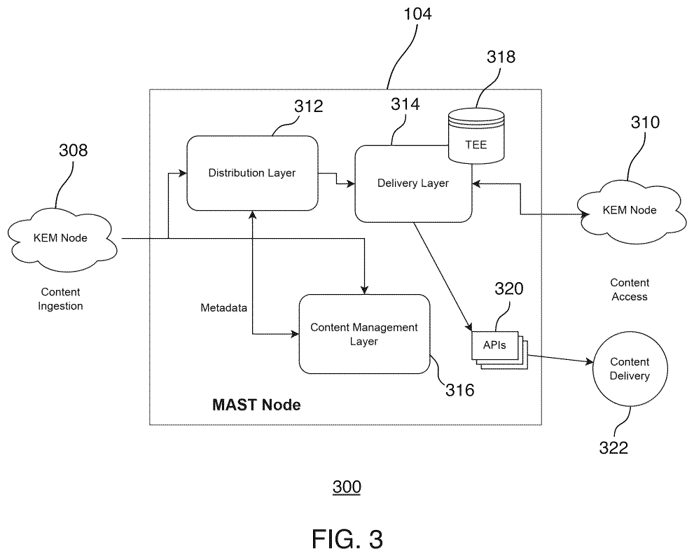

FIG. 3 is a block diagram of an example environment 300, including a MAST node and associated flow in relation to layers of the MAST node and to KEM nodes. Shown is the MAST node 104 of FIG. 1. Also shown are KEM nodes 308 and 310, either of which may be used to represent the KEM node 108 of FIG. 1. As noted above, the KEM node 108 of FIG. 1 may represent multiple KEM nodes.

Referring still to FIG. 3, as indicated above, the MAST node 104 functions to provide handling of the storage, metadata, decryption, and dissemination of digital media content. The MAST node 104 optimizes the distribution process, ensuring that content is delivered efficiently and securely to end-users.

The MAST node 104 has various layers, including a distribution layer 312, a delivery layer 314, a content management layer 316. The content management layer 316 could exist in the KEM node 108 in some implementations, as a trusted node. Also shown are a trusted execution environment (TEE) 318 (or other secure enclave), application programming interfaces (APIs) 320, and a circle representing content delivery, or content delivery 322.

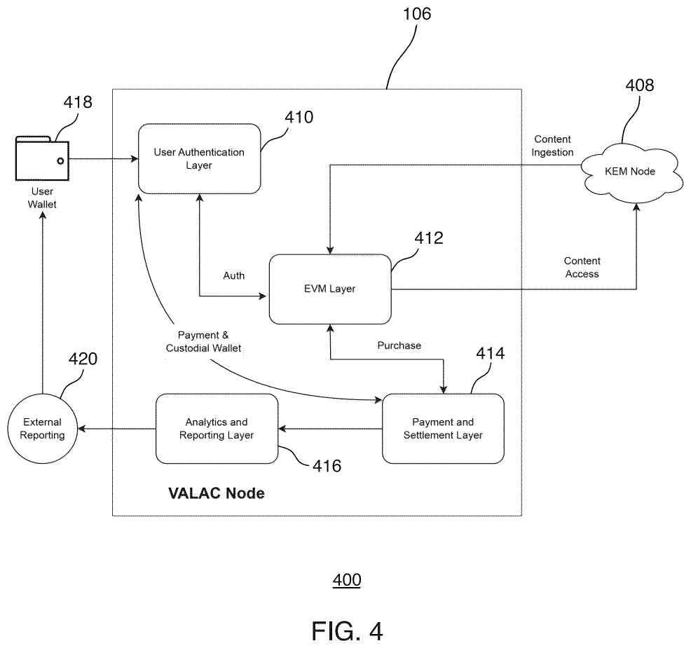

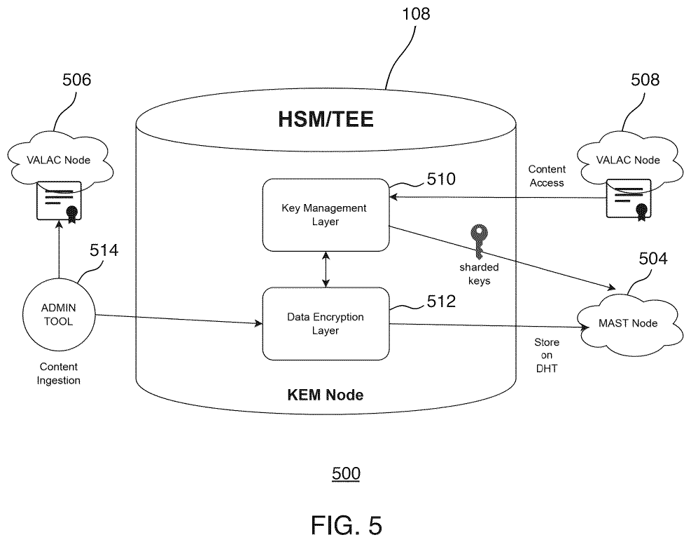

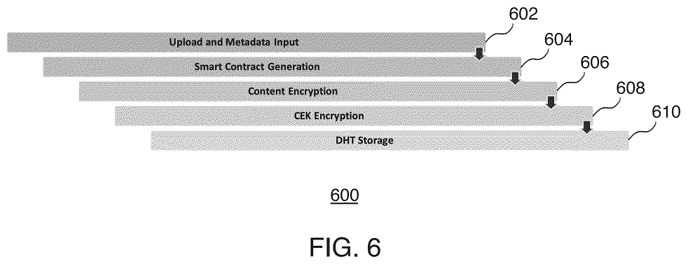

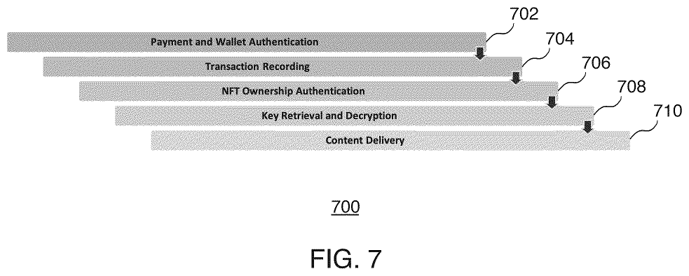

As described herein, the MAST node(s) (FIGS. 1 and 3), the VALAC node(s) (FIGS. 1 and 4), and the KEM node(s) (FIGS. 1 and 5) and their respective internal layers collaborate to maintain the operations of the system 102 and/or the PERMA platform. For example, the KEM node 306 may collaborate with the distribution layer 312 and the content management layer 316 in connection with content ingestion. Also, the KEM node 308 may collaborate with the delivery layer 314 in connection with content delivery. Example embodiments directed to content ingestion and content delivery and other operations of the MAST node 104 are described in more detail herein, in connection with FIGS. 6 and 7, for example.

In various embodiment, the distribution layer 312 is responsible for decentralized storage and distribution of digital media across a decentralized network, including retrieval of encrypted media files and keys. The distribution layer 312 shares metadata with the content management layer 316. The distribution layer also uses a distributed hash table (DHT) protocol, for example, which is modified for specific operations of the system 102 (FIG. 1), ensuring the encrypted content is stored redundantly across a network of nodes for reliable access. After the KEM's data encryption layer 512 chunks and encrypts the digital content, the distribution layer 312 then stores digital content and metadata in a distributed manner across various nodes within the network. This ensures redundancy and enhances access speed. The distribution layer 312 ensures scalability and efficiency in the face of rapidly increasing content volumes and user numbers. The distribution layer 312 also balances the load across the decentralized network to prevent bottlenecks.

The distribution layer 312 also benefits from edge caching or content delivery networks (CDNs) to cache and serve popular content quickly. In various embodiments, the distribution layer 312 provides edge caching and CDNs with blockchain. The distribution layer 312 provides integration of traditional edge caching and CDNs to increase delivery speed. This is a hybrid between Web2 and Web3 technologies.

In various embodiment, the delivery layer 314 securely delivers content to users via various APIs while implementing anti-piracy measures. The delivery layer 314 decrypts and securely delivers content, such as streaming. The delivery layer 314 is equipped with one or more TEEs 318 (i.e., secure enclaves) for the secure decryption of digital content and employs anti-piracy measures and digital rights management (DRM). The deliver layer 314 also interacts with APIs 320 for content delivery 322.

In various embodiments, the delivery layer 314 receives decrypted content encryption keys (CEKs) from the key management layer of the KEM node 108 through secure inter-node communication. This allows for the decryption of the content chunks retrieved from the DHT Layer within a secure enclave before secure streaming or access, employing industry standard anti-piracy measures and DRM.

In various embodiments, the delivery layer 314 provides a buyback notification feature. In lieu of traditional Digital Millennium Copyright Act (DMCA) takedown tools, the system 102 provides offers copyright owners with the option to initiate a buyback request for their digital content. This feature addresses potential licensing issues or unauthorized uploads discovered post-curation. The buyback request may be initiated in-system through APIs when a user accesses their content.

In various embodiments, the delivery layer 314 provides sharded key reconstitution. For example, when a user is verified for content access, an Ethereum virtual machine (EVM) layer such as EVM layer 412 of FIG. 4 gives the key management layer authorization to send the sharded CEK to the delivery layer 314 for content decryption. The delivery layer 314 requests the location of the content via the content management layer 316. Once located, the chunked files are retrieved from the DHT. Specifics surrounding the handling of the content will change depending on type and its associated delivery APIs. The delivery layer 314 then reconstitute the sharded fragments securely within a TEEs and decrypt the content for delivery.

In various embodiments, the delivery layer 314 provides scalable APIs capable of handling high request volumes. The delivery layer 314 also implements sophisticated DRM solutions to prevent unauthorized distribution and piracy. The delivery layer 314 provides a DRM that is effective yet non-intrusive to legitimate users, and maintaining a balance between security and speed.

In various embodiment, the content management layer 316 is responsible for managing content metadata and cataloging on the platform. This layer adapts database-like structures for a decentralized environment. The content management layer 316 also ensures efficient retrieval of content within the network of the system 102, enhancing the overall user experience.

In various embodiments, the content management layer 316 handles metadata management and indexing, making it easy for users to find and access content. Furthermore, the content management layer 316 helps the delivery layer 314 locate content within the DHT. The content management layer 316 also adapts traditional content management systems and databases to a decentralized architecture. The content management layer 316 provides efficient media file metadata management for quick indexing and retrieval, and ensures accuracy and consistency of metadata across a distributed network. The content management layer 316 also manages content validation and curation while maintaining decentralization.

In other implementations, the environment 300 may not have all of the components or elements shown and/or may have other elements including other types of elements instead of, or in addition to, those shown herein.

FIG. 4 is a block diagram of an example environment 400, including a VALAC node and associated flow in relation to layers of the VALAC node and to a KEM node. Shown is the VALAC node 106 of FIG. 1. Also shown is a KEM node 408, which may be used to represent the KEM node 108 of FIG. 1.

As indicated above, the VALAC node 106 functions to provide user authentication, access control, payment processing, and financial transactions. The VALAC node 106 is responsible for managing access rights to content and validating transactions. VALAC node 106 integrates smart contract execution and user access management to ensure that only authorized individuals can access content.

The VALAC node 106 has various layers, including a user authentication layer 410, an Ethereum virtual machine (EVM) layer 412, a payment and settlement layer 414, and a combined analytics and reporting layer 416. Also shown are a user wallet 418 and a circle representing external reporting, or external reporting 420.

As indicated above and described herein, the MAST node(s) (FIGS. 1 and 3), the VALAC node(s) (FIGS. 1 and 4), and the KEM node(s) (FIGS. 1 and 5) and their respective internal layers collaborate to maintain the operations of the system 102 and/or the PERMA platform. For example, the KEM node 408 may collaborate with the EVM layer 412 in connection with content ingestion and content delivery. Example embodiments directed to content ingestion and content delivery and other operations of the VALAC node 106 are described in more detail herein, in connection with FIGS. 6 and 7, for example.

In various embodiment, the user authentication layer 410 operates in tandem with the EVM layer 412 to authenticate users via APIs allowing the direct connectivity of wallets, both private or custodial. The user authentication layer 410 receives user wallets such as the user wallet 418 for payment processing.

In various embodiments, the user authentication layer 410 ensures that only authenticated users can access and interact with the platform. The user authentication layer 410 also verifies the authenticity of user wallets and their associated permissions. It provides distinct APIs for both authorized and public access, enabling direct platform authentication for both custodial and private wallets. The user authentication layer 410 communicates with the EVM Layer to verify the connected wallet's NFTs, as well as the Payment and Settlements Layer to verify authorized custodial wallets.

In various embodiments, the user authentication layer 410 performs an authentication process. For example, when a user attempts to access the platform, they can choose to authenticate either through a centralized app or by connecting their private wallet directly. If the user chooses to authenticate through a centralized app, they log in using their credentials, and the app verifies their identity and wallet association. If the user opts to connect their private wallet directly, the API of the authentication layer 410 facilitates the connection and verifies the wallet's authenticity. Once the user's identity or wallet is verified, the authentication layer communicates with the EVM layer to check the user's NFT ownership and grant access based on the associated content permissions.

In various embodiments, the user authentication layer 410 provides a wallet-agnostic authentication system that can handle both custodial and private wallets seamlessly. The user authentication layer 410 enables public APIs to connect with the EVM layer 412. The user authentication layer 410 ensures performance of the authentication process as the number of users and content grows. The user authentication layer 410 balances stringent security measures with user-friendly access procedures.

In various embodiments, the user authentication layer 410 provides physical-digital authentication. In various embodiments, user authentication layer 410 couples physical goods with digital non-fungible tokens (NFTs) using tamper-evident near-field communication (NFC) tags/stickers. The system 102 links NFC tag data with blockchain records and verifies authenticity and/or ownership.

In various embodiment, the EVM layer 412 utilizes EVM standards, or equivalent. The EVM layer 412 securely records all blockchain transactions, as well as manages access control through smart contracts. The EVM layer 412 also allows for authorization based on NFT ownership. The EVM layer 412 provides a transparent and immutable record of transactions, and a secure system for access control within the PERMA ecosystem.

In various embodiments, the EVM layer 412 utilizes the EVM to record transactions, transfers, and media file purchases, as well as execute smart contracts that govern access control logic. It initiates content delivery approval within the key management layer of the KEM node 108 based on authorized NFT ownership. The EVM layer 412 provides smart contract integration. Smart contracts automate various processes like verifying user authorization, and enforcing access control policies based on the specific requirements of each piece of content.

In various embodiments, the EVM layer 412 provides content access approval. For example, when a user wants to access a specific piece of content, they send a request to the EVM layer 412, providing proof of NFT ownership via their connected private or custodial wallet. The smart contract verifies the use's NFT ownership and checks if they satisfy the access control policies for the requested content. If the user is authorized to access the content, the smart contract sends the approval via inter-node communications with the key management layer of the KEM node 108 to begin the process of content delivery.

In some embodiments, the VALAC node 106 may use Layer 2s such as optimistic stack to reduce load on the EVM layer to help with Layer 1 loads. In some embodiments, Layer 1 may be the Ethereum Mainnet.

In various embodiments, the EVM layer 412 integrates with the KEM node 108 for secure communications. The EVM layer 412 also provides smart contract enhancements to ensure low gas overhead, and integrates inter-node end-to-end encrypted communication seamlessly across the VALAC node 106 and the KEM node 108.

In various embodiment, the payment and settlement layer 414 handles financial transactions such as cryptocurrency and traditional payment methods. This layer integrates with crypto wallets and conventional payment gateways, as well as secure creation and management of custodial wallets. The payment and settlement layer 414 is also responsible for processing transactions efficiently, ensuring the platform's financial operations run smoothly. The payment and settlement layer 414 is responsible for processing and recording financial transactions on the platform. The payment and settlement layer 414 supports both cryptocurrency and fiat payments, integrating with various blockchain networks and traditional payment gateways (e.g., Stripe). The payment and settlement layer 414 also manages the creation and secure storage of custodial wallets for users who opt-in to use them.

In various embodiments, the payment and settlement layer 414 performs settlement and reconciliation to ensure accurate and timely settlement of transactions, maintaining a transparent record on the blockchain. The payment and settlement layer 414 also provides custodial wallet management. For example, for use in authorized applications, the payment and settlement layer 414 creates and manages custodial wallets via a secure administrative API. When a new custodial wallet is requested, the layer generates a unique wallet address and its associated public/private key. The public key is stored on-chain for transparency and verification, while the private key is securely returned to the designated administrator and never stored on-chain. This functionality is primarily designed for authorized centralized applications that require account creation for know-your-customer (KYC) compliance.

In various embodiments, the payment and settlement layer 414 integrates with various blockchain networks for cryptocurrency transactions. The payment and settlement layer 414 supports traditional payment methods, including credit cards, through third-party gateways. The payment and settlement layer 414 ensures the security and privacy of financial transactions. The payment and settlement layer 414 balances the transaction speed with blockchain confirmation times and traditional banking protocols.

In various embodiment, the combined analytics and reporting layer 416 provides insightful analytics on user behavior, wallet-identified user behavior, content popularity, and transactional data and trends. The combined analytics and reporting layer achieves these analytics by utilizing data analysis tools and blockchain transaction tracking mechanisms.

In various embodiments, the combined analytics and reporting layer 416 gathers and analyzes data from various interactions within the platform. The combined analytics and reporting layer 416 includes a reporting mechanism, where the combined analytics and reporting layer 416 generates reports that help in decision-making, platform optimization, and understanding user needs.

In various embodiments, the combined analytics and reporting layer 416 provides comprehensive data analysis tools for user behavior and content popularity insights. The combined analytics and reporting layer 416 includes reporting mechanisms aiding decision-making and platform optimization. The combined analytics and reporting layer 416 provides accurate processing and interpretation of large volumes of transactional and interaction data. The combined analytics and reporting layer 416 also maintains user privacy while collecting detailed analytical data.

In other implementations, the environment 400 may not have all of the components or elements shown and/or may have other elements including other types of elements instead of, or in addition to, those shown herein.

FIG. 5 is a block diagram of an example environment 500, including a KEM node and associated flow in relation to layers of the KEM node, to a MAST node, and to VALAC nodes. Shown is the KEM node 108 of FIG. 1. Also shown is a MAST node 504, which may be used to represent the MAST node 104 of FIG. 1. Also shown are VALAC nodes 506 and 508, either of which may be used to represent the VALAC node 106 of FIG. 1. As noted above, the VALAC node 106 of FIG. 1 may represent multiple VALAC nodes.

As indicated above, the KEM node 108 functions to provide cryptographic key management and encryption during a content ingestion phase. The KEM node 108 is responsible for the secure generation, management, and distribution of cryptographic keys, as well as the chunking and encryption of content. The KEM node 108 is classified as trusted, meaning they are operated by vetted entities to ensure the highest level of security. KEM Nodes work closely with other layers in the MAST node 104 and the VALAC node 106 to facilitate secure content encryption and decryption processes.

The KEM node 108 has various layers, including a key management layer 510, and a data encryption layer 512. Also shown is an admin tool 514. As indicated above and described herein, the MAST node(s) (FIGS. 1 and 3), the VALAC node(s) (FIGS. 1 and 4), and the KEM node(s) (FIGS. 1 and 5) and their respective internal layers collaborate to maintain the operations of the system 102 and/or the PERMA platform. For example, the MAST node 502 may collaborate with the key management layer 510 in connection with sharded keys and may collaborate with the data encryption layer 512 in connection with DHT associated storage. The VALAC node 506 may collaborate with the data encryption layer 512 via an admin tool such as admin tool 514 in connection with content ingestion. The VALAC node 508 may collaborate with the key management layer 510 with content access and delivery. Example embodiments directed to content ingestion and content access and delivery and other operations of the KEM node 108 are described in more detail herein, in connection with FIGS. 6 and 7, for example.

In various embodiments, the key management layer 510 handles the management of content encryption keys (CEKs) and master encryption keys (MEKs). The key management layer 510 is responsible for the creation and management of content encryption keys (CEKs) and master encryption keys (MEKs).

In various embodiments, the key management layer 510 derives one or more master encryption keys (MEKs) from secret inputs. The key management layer 510 derives the MEKs using a key derivation function with secret inputs, including the smart contract address associated with specific content. The key management layer 510 uses the MEK to decrypt one or more stored cryptographic keys.

The key management layer 510 also securely shards and delivers CEKs to the MAST node 103 for content decryption. As described in more detail herein, in various embodiments, the key management layer 510 provides an on-demand key reconstitution process, where the key management layer 510 re-derives the MEKs is to decrypt the stored CEKs, which are then sharded and securely sent to the delivery layer 314 of the MAST node 104.

When the data encryption layer 512 requests a new CEK for a piece of content, the key management layer generates a unique CEK. The key management layer 510 securely generates, manages, and distributes cryptographic keys used for content encryption and decryption. The key management layer 510 utilizes advanced cryptographic techniques, including Shamir's Secret Sharing, to ensure the secure generation and management of these keys.

In various embodiments, the MEK is derived using a key derivation function (KDF), such as HKDF or Argon2, with secret inputs, including the smart contract address associated with the specific piece of content and other secure parameters determined by the KEM node 108. The CEK is encrypted using the derived MEK. The encrypted CEK is then securely stored within the KEM node 108, accessible only through authorized requests from the EVM layer 412.

In various embodiment, the key management layer 510 provides on-demand key reconstitution. For example, when the EVM layer 412 sends an authorization request to access content, the key management layer 510 receives the request. The key management layer 510 uses the provided smart contract address as an input parameter in a key derivation function (KDF) to re-derive the MEK to decrypt the stored CEK. Once decrypted, the CEK is sharded using Shamir's secret sharing (SSS). The key management layer 510 then initiates an inter-node communication with delivery layer 314 of the MAST node 104 to send the sharded pieces of the content's CEK. The delivery layer 314 then reconstitutes the fragments securely within a TEEs and decrypt the content for delivery.

In various embodiments, the key management layer 510 utilizes advanced key derivation techniques to generate MEKs, ensuring a strong link between the content and its associated smart contract. The key management layer 510 implements secure key storage mechanisms within the KEM node 108, leveraging secure enclaves, e.g., TEEs or hardware security modules (HSMs), for enhanced protection. The key management layer 510 employs key sharding techniques to distribute key fragments among multiple KEM node 108.

In various embodiments, the key management layer 510 ensures the scalability and performance of key generation and management processes as the volume of content grows. The key management layer 510 maintains the security and integrity of the key management system in the face of potential threats or attacks. The key management layer 510 optimizes the key reconstitution process to minimize latency and ensure prompt content access for authorized users

In various embodiment, the data encryption layer 512 ensures the confidentiality of imported media files. The data encryption layer 512 works in tandem with the key management layer 510 to encrypt content files before transferring them to DHT of the MAST node 104 for storage.

In various embodiments, the data encryption layer 512 provides an encryption process, where the data encryption layer 512 utilizes state-of-the-art encryption algorithms such as AES-256-GCM and XChaCha20-Poly1305 for file encryption. The data encryption layer oversees data encryption before storage within the DHT. For example, the data encryption layer 512 receives the content file from an external admin interface, and requests a unique CEK from the key management layer 510. Upon receiving the CEK, the layer clunks and applies the selected encryption algorithm to the content file. Once the encryption is complete, the encrypted content file is securely transferred to the DHT for storage and distribution.

In various embodiments, the data encryption layer 512 utilizes advanced, quantum-resistant encryption techniques. The data encryption layer 512 optimizes the encryption process to handle large volumes of content efficiently. The data encryption layer 512 ensures the performance and scalability of encryption processes for large volumes of media content. The data encryption layer 512 also ensures the compatibility of the encrypted content with storage and distribution mechanisms of the MAST node 104.

For ease of illustration, some embodiments are described in the context of one MAST node 104, one VALAC node 106, and one KEM node 108. As indicated herein, there may be any number of each of these node types. Also, each of these nodes may include additional or fewer layers as described, depending on the particular implementation.

In other implementations, the environment 500 may not have all of the components or elements shown and/or may have other elements including other types of elements instead of, or in addition to, those shown herein.

FIG. 6 and FIG. 7 describe the entire journey of a piece of digital content within the PERMA (permissioned encrypted and redundant media access) file distribution platform or system, from initial ingestion of digital content to its final delivery to the end-user. FIGS. 6 and 7 provide a detailed overview of the two main processes: content ingestion and content access.

FIG. 6 is a flow chart for providing content ingestion. Referring to FIGS. 3 to 6, a method is initiated at block 602, where a system such as system 102 receives new digital content and metadata associated with the digital content that is uploaded by a user.

As indicated above, the digital content may be a digital movie for example. An administrator uploads the digital content (e.g., digital files) and associated information or metadata associated with the digital content. The uploading may be achieved through an admin tool. In various embodiments, the admin tool ensures that only compliant material is added to the system 102. In various embodiments, the relevant metadata may include a title, a description, a genre, the cast, crew information, inventory, a price, etc. Such metadata may be used to help categorize and identify the digital content within the ecosystem of the system 102.

At block 604, the system 102 generates a smart contract. Once all the correct information and media files are added and validated, the system 102 proceeds to generate a smart contract using the EVM layer of the VALAC node 106. In various embodiments, the smart contract is a self-executing program that holds or contains the details and access rules for the digital content once it is purchased, serving as the digital representation of the digital content on the blockchain.

At block 606, the system 102 encrypts the digital content and metadata. After the smart contract is deployed, the system 102 chunks then encrypts the digital content files using advanced cryptographic techniques. The system 102 performs the encryption using the data encryption layer of the KEM node 108, which handles this process. The data encryption layer works in tandem with the key management layer 510 of the KEM node 108 to generate a unique content encryption key (CEK) for each chunked segment of digital content. The CEK is used to encrypt each chunk of the content files, ensuring that they are secure and inaccessible to unauthorized parties.

At block 608, the system 102 encrypts the CEKs. In various embodiments, to further enhance security, the system 102 uses the KEM node 108 to encrypt the CEK using a master encryption key (MEK). The system 102 generates the MEK by leveraging internal cryptographic functions with secret inputs including the public smart contract address. This ensures that key generation is as secure and isolated as possible within the trusted environment. This multi-layered encryption approach also ensures that the CEK is tied to the contract and thus to the purchased content.

At block 610, the system 102 stores a distributed hash table (DHT). In various embodiments, the DHT enables secure and efficient data sharing while ensuring low-latency access. Once encrypted, the MAST node 104 of the system 102 stores the digital content across a distributed hash table (DHT) in the distribution layer of the MAST node 104. The DHT enables efficient and redundant storage of data across a network of nodes, ensuring high availability and resilience.

In various embodiments, the system 102 provides a curated content ingestion system. The system 102 vets content before ingestion into the decentralized platform, which is a novel approach compared to open systems that require moderation. Even though some platforms seem to have some type of curation, they are different from the PERMA platform in that they either offer purchases that are not immutable and irrevocable, or do not offer purchasing options for consumers. As described herein, the system uses DHT, which allows for multiple media types. As such, the system 102 is not limited to just one type of media or file type within the curated system.

In other implementations, the flow of FIG. 6 may not have all of the steps shown and/or may have other steps instead of, or in addition to, those shown herein.

FIG. 7 is a flow chart for providing content access. Referring to FIGS. 1 to 5 and to FIG. 7, a method is initiated at block 702, where the system 102 authenticates a payment and wallet. In various embodiments, when a user purchases digital content on the platform of the system 102, the user interacts with a centralized application, such as a web application or mobile app. In various embodiments, the system 102 supports both cryptocurrency and fiat currency payments.

If the user chooses to pay with fiat currency, the system 102 may require the user to create an account and complete a know-your-customer (KYC) process to comply with applicable regulations. As part of this process, the system uses the payment and settlement layer of the VALAC node 106 securely to create a custodial wallet for the user at the request of the centralized app. This process generates a unique wallet address and associated key pair. The public key is stored on-chain, while the private key is securely saved in the centralized application's backend, and is associated to the user's login credentials. In various embodiments, private keys are never stored on-chain. At any time, users may transfer purchases out of their custodial wallets and into private ones.

In the case of cryptocurrency payments, the system 102 may enable users to have an option of using their own private wallets. The system 102 enables users to link their wallets directly to the user authentication layer of the VALAC node 106. This eliminates a need for a separate account creation process and enhances user privacy, as their personal information is not always required for cryptocurrency transactions.

At block 704, the system 102 records the transaction. Once the payment is processed, whether through fiat currency or cryptocurrency, the system 102 records the transaction on-chain via the EVM layer of the VALAC node 106. This process involves minting a non-fungible token (NFT) that represents the user's ownership of the purchased digital content. The NFT is then “sent” to the user's designated wallet, which could be their private wallet or the custodial wallet created during the fiat payment process mentioned above.

At block 706, the system 102 authenticates NFT ownership. To access the purchased content, the user authenticates themselves through the user authentication layer of the VALAC node 106. If the user has a custodial wallet, they log in through the centralized app, which verifies their identity and wallet association. For users with private wallets, authentication is performed by connecting their wallet directly to the platform using the user authentication layer's API. The centralized application might not be involved in this process, as it will primarily serve as an intermediary for custodial wallet users.

At block 708, the system 102 retrieves and decrypts the CEK. Once the wallet is authenticated, system 102 causes the user authentication layer of the VALAC node 106 to communicate with the EVM layer of the VALAC node 106 to verify the user's NFT ownership and grant access to the content based on the permissions associated with the NFT. If the user is authorized, the EVM layer initiates a secure inter-node communication to the key management layer 510 of the KEM node 108 to request the encrypted CEK for the content.

The key management layer of the KEM node 108 securely re-derives the MEK and decrypts the CEK. After the CEK is decrypted, it is then “sharded.” In various embodiments, the KEM node 108 may shard the CEK using Shamir's Secret Sharing (SSS) and securely distributed to the delivery API Layer of the MAST node 104 using end-to-end encryption. This ensures that the sharded CEK fragments remain secure during transit.

At block 710, the system 102 delivers the content. Upon receiving the sharded pieces, the system 102 uses the delivery layer of the MAST node 104, equipped with trusted execution environments (TEEs), to reconstitute the decrypted CEK. The system 102 then uses the content management layer of the MAST node 104 (or the trusted KEM node 108 in some implementations) to locate the associated content within the DHT and retrieve it. The content is then decrypted within the delivery layer using the CEK. The decrypted content may then be securely streamed or accessed by the user, utilizing the appropriate media type specific API and applying necessary DRM and anti-piracy measures. These measures help protect the content from unauthorized distribution and ensure that only legitimate purchasers can access the content.

In other implementations, the flow of FIG. 6 may not have all of the steps shown and/or may have other steps instead of, or in addition to, those shown herein.

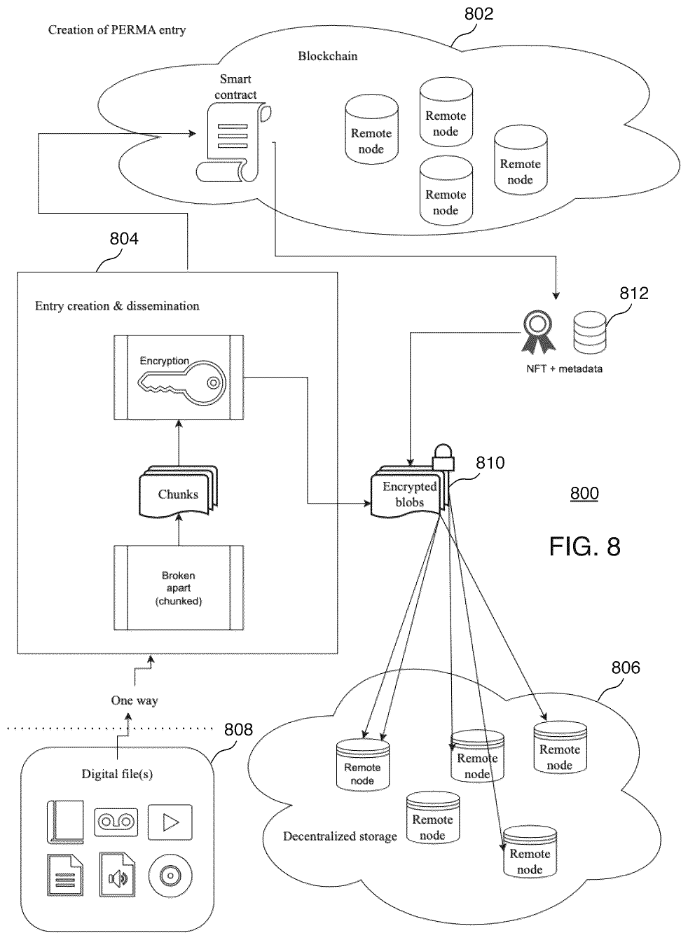

FIGS. 8, 9, and 10 describe additional embodiments that may be used to execute implementations described herein.

FIG. 8 is a block diagram of an example environment 800 including a permissioned encrypted and redundant media access file distribution system with decentralized storage, and involving creation of PERMA entry. Shown are a blockchain 802, an entry creation and dissemination block 804, a decentralized storage 806, digital files 808, encrypted blobs 810, and NFT and metadata 812.

In various embodiments, the system 102 (FIG. 1) provides a decentralized file distribution platform including an entry and dissemination subsystem, a blockchain subsystem, and a decentralized distribution system. The system 102 securely and efficiently distribute digital files, including but not limited to digital media. The system 102 provides an innovative combination of decentralized distribution methods and the ability to transfer ownership of digital files. Its foundational features center around the principles of encryption, decentralized storage, unique identification, and on-chain ownership verification, offering a new paradigm in digital file ownership and control.

In various embodiments, the system 102 transforms digital files, input into the system 102, into secure, encrypted entities, that are then distributed across a decentralized network of nodes such as remote nodes of the blockchain 802 and/or the decentralized storage 806. This distribution not only ensures the security and confidentiality of the digital files but also provides redundancy. In the context of the system's decentralized network, redundancy means that multiple copies of the same digital file are stored across different nodes in the network. This redundancy enhances the reliability and robustness of the system, safeguarding against potential data loss. Even if certain nodes in the network experience downtime or failure, the digital files remain accessible from other nodes, providing continuous access to files. This transformation process maintains a high degree of security, ensuring the digital files are resistant to unauthorized access and copying.

In various embodiments, the system 102 utilizes technology that incorporates decentralized distribution methods, such as a DHT, that enables secure and efficient data sharing while ensuring low-latency access. This makes it highly effective for real-time applications like streaming videos. Furthermore, the system uses advanced encryption algorithms such as, for example, advanced encryption standard (AES), an industry-standard algorithm, to enhance security and protect the confidentiality and integrity of the transmitted data.

The system 102 embodies the immutable nature of physical ownership in the digital realm, rendering it a one-way distribution model. Once a digital file such as one of digital files 808 is ingested into the system, curated, and associated with a unique NFT 812, it essentially becomes the “property” of the NFT owner. Just like a physical media distributor cannot reclaim a sold Blu-ray disc, for instance, the distribution of files within the system is irreversible. This immutability enhances the perception and reality of ownership for the consumers and is at the heart of the system's purpose or mission to bring the principles of physical ownership to the digital world.

An intrinsic characteristic of the system 102 is its anti-piracy and digital rights management (DRM) mechanisms, inherently constructed to safeguard the rights of digital file copyright owners. The DRM mechanisms are facilitated through secure APIs that define the specific methods of access for different types of files, such as, for example streaming videos or interactive in-game 3D models. By linking access to the file's decryption and use solely to the ownership of a corresponding NFT, the system inherently prevents unauthorized duplication, retention, and distribution. It ensures that the access to these files is strictly permissioned. The digital file remains securely encrypted until the NFT ownership is verified on-chain using the blockchain subsystem, and only then is the file decrypted for access. As ownership changes, the access rights are seamlessly transferred, thereby eliminating the risk of unauthorized retention or duplication.

In other implementations, the environment 800 may not have all of the components or elements shown and/or may have other elements including other types of elements instead of, or in addition to, those shown herein.

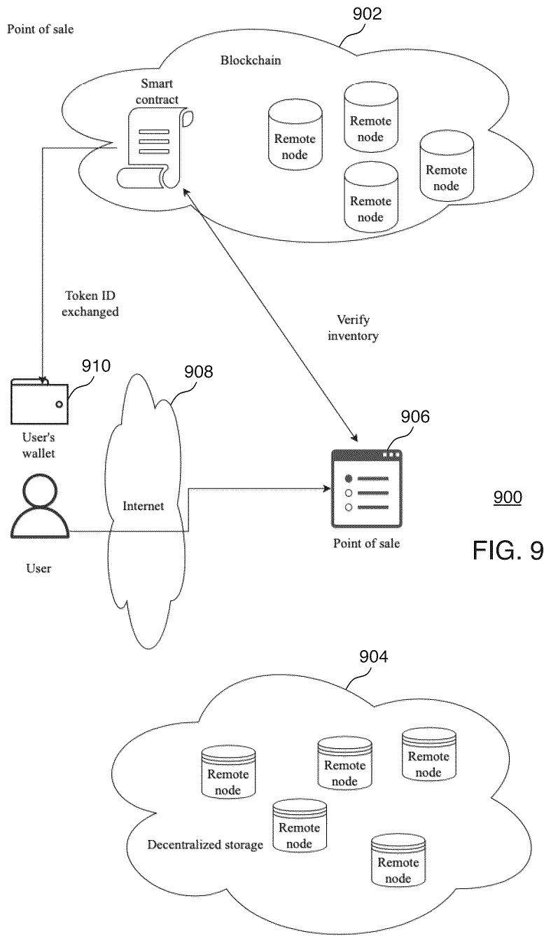

FIG. 9 is a block diagram of an example environment 900 including a permissioned encrypted and redundant media access file distribution system with decentralized storage, and involving a point of sale. Shown are a blockchain 902, a decentralized storage 904, a point-of-sale subsystem 906, a network such as the Internet 908, and a user's wallet 910.

A user accesses the available digital entities via the Internet 908 and the point-of-sale subsystem 906. The point-of-sale subsystem 906 will query the blockchain subsystem or blockchain 902 for available digital entities and display them to the user. When the user selects an item on the list, the user's digital wallet 910 is accessed for payment by the point-of-sale subsystem 906. Using the same blockchain 902, the user's wallet 910 exchanges a token identification with the blockchain to verify and authenticate the user. When the transaction is complete, the user's wallet 910 includes the digital entity or entities that the user purchased from the point-of-sale subsystem 906. At this point the user “owns” the digital entity or entities that the user purchased. Then, the point-of-sale subsystem 906 and the blockchain 902 distribute the new ownership information throughout all the active nodes in the system, thereby ensure that the user can claim ownership of the digital entity or entities from anywhere. Finally, the point-of-sale subsystem 906 and the blockchain 902 update the available digital entities with the blockchain 902 so that an accurate inventory is maintained.

In various embodiments, the system 102 enables the coupling of physical goods with their digital counterparts via NFTs, thereby providing a digital certificate of authenticity or provenance. This function can enhance the authenticity of physical goods and further expands the utility of the PERMA platform.

In various embodiments, within the digital gaming and metaverse domain, game assets such as character skins, avatars, weapon models, or even entire game levels, along with elements like digital furniture or apparel in a metaverse, can be bought, owned, and sold using the system. This not only assures genuine ownership but also enables users to transport their assets across different gaming or virtual platforms, blurring the boundaries between disparate digital universes and introducing a new paradigm of interoperability and user agency.

In various embodiments, the PERMA platform is a decentralized, permanent repository for digital content, which provides scalability in offering access to digital content such as 3D models, game assets, etc. via various environments such as AR/VR, Metaverse, consoles, etc. The system utilizes the same token ownership structure, and, as such, the various types of digital content is made interoperable.

In other implementations, the environment 900 may not have all of the components or elements shown and/or may have other elements including other types of elements instead of, or in addition to, those shown herein.

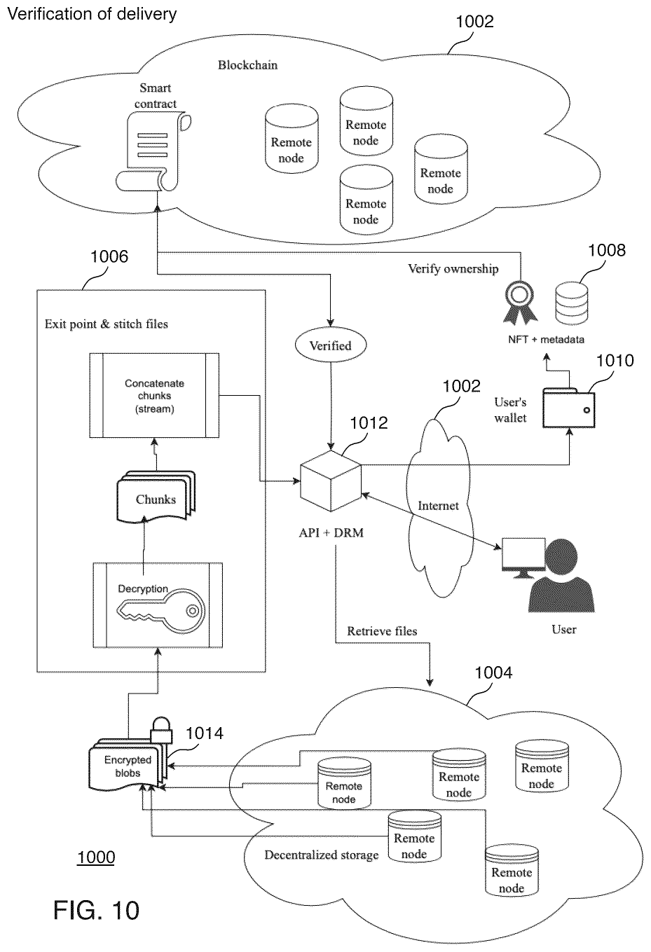

FIG. 10 is a block diagram of an example environment 1000 including a permissioned encrypted and redundant media access file distribution system with decentralized storage, and involving verification of delivery. Shown are a blockchain 1002, a decentralized storage 1004, an exit point and stitch files block 1006, NFT and metadata 1008, a user's wallet 1010, an API and digital rights management (DRM) block 1012, and encrypted blobs 1014.

The system 102 (FIG. 1) incorporates the use of NFTs 1008 as a means of representing and transferring digital ownership of these digital files. As indicated herein, NFTs 1008, as utilized herein, are cryptographic tokens that are distinct and indivisible, representing a specific digital asset or right. NFTs 1008 enable the secure ownership, transfer, and authentication of digital assets, including digital media files, within a decentralized network such as blockchain 1002 or decentralized storage 1004.

Unique NFTs 1008 are associated with each encrypted file, establishing a one-to-one relationship between the digital item and its corresponding NFT 1008. These NFTs 1008 serve as digital keys, granting access to the linked digital files only to verified owners. NFTs 1008 effectively simulate the scarcity and exclusivity of physical ownership within the digital realm.

In other implementations, the environment 1000 may not have all of the components or elements shown and/or may have other elements including other types of elements instead of, or in addition to, those shown herein.

The follow are additional embodiments enabled by the system 102. In various embodiments, the original copyright owners can directly offer to buy back the digital file via the system. However, this mechanism is consumer-centric, and the digital file owner is under no obligation to accept this offer, thereby further empowering the consumer's control over their digital assets.

The verification of NFT ownership is performed on-chain, harnessing the transparency and security of blockchain technology. This method ensures tamper-proof ownership verification.

The system brings the principles of the First Sale Doctrine to the digital domain, allowing NFT owners to buy, sell, rent, loan, or otherwise transfer their ownership rights, similar to how they would with physical purchases. This distinctive application affords consumers unprecedented control over their digital purchases.

In a further application, the NFTs in the system also function akin to database entries. Each NFT contains metadata associated with the digital file it represents, effectively serving as a database record of the purchase. This metadata might include, for instance, details such as the author, publisher, and ISBN if the file is a book. Each NFT also includes a thumbnail image representing the digital file, such as a book cover or a movie poster. For more complex digital files like 3D models, the thumbnail might be an interactive representation, such as a rotating GL transmission file format of the model. This approach gives the NFT a dual function, not only acting as a key to unlock and authenticate the digital content, but also serving as a comprehensive, easily accessible record of the digital asset, enhancing the user experience and the organizational possibilities within the digital library.

Embodiments described herein have multifaceted implementations, supporting a range of digital applications. For example, applied to media distribution, embodiments provide consumers with true ownership rights over their digital media purchases, replicating the First Sale Doctrine protections. Applied to digital collectibles, embodiments facilitate the creation and distribution of digital collectibles (e.g., trading cards, avatars, etc.) tied to specific media content. Applied to authentication of physical goods, embodiments couple physical goods with their digital counterparts via tamper-evident, passive NFC tags linked with NFTs, providing digital certificates of authenticity. Applied to interoperability in gaming and metaverse, embodiments enable genuine ownership and cross-platform transportability of digital assets in gaming and metaverse environments, including 3D models, skins, etc. Applied to spatial computing, embodiments facilitate the distribution of digital tools, weighted AI models, and software, akin to the traditional distribution of software on CDs, within spatial computing environments. Applied to educational content, embodiments provide secure distribution of educational materials, ensuring access only to authorized students or institutions. Applied to corporate use, embodiments securely share confidential corporate data, from media files to legal documents, within and between organizations.

Embodiments described herein have numerous benefits. For example, embodiments provide a new and improved system for a permissioned encrypted and redundant media access file distribution system. Embodiments also provide a unique application of digital ownership rights, coupled with its added utility of digital authentication for physical goods, including a robust and adaptable platform for various applications in the digital and physical goods space.

Embodiments revolutionize digital media distribution by creating a comprehensive, decentralized platform that empowers creators, protects intellectual property rights, and ensures fair and permanent ownership for consumers. By leveraging blockchain technology, advanced encryption, and a multilayered architecture, embodiments establish a secure, transparent, and efficient ecosystem for the creation, distribution, and consumption of digital content. The platform addresses the shortcomings of the current digital media landscape, striking a balance between consumer protection and IP owners' rights.

Embodiments deliver a secure and consumer-centric platform for digital media distribution by leveraging blockchain, low-latency distributed storage, trusted key management, and advanced encryption. Embodiments enable purchase of digital content that is truly owned by the purchaser of the digital content, similar to buying a physical book or Blu-Ray. Embodiments provide a one-way distribution model and unalterable NFT-based ownership ensure that purchases remain the property of the purchaser, no matter what. Embodiments align with the principles of the First Sale Doctrine while protecting digital purchases.

Embodiments provide a layered architecture inter-node communication and interoperability among nodes or layers of the system. Embodiments also provide key management and sharding or scattering of digital content on the nodes or layers. Furthermore, some embodiments are associated with replication of the First Sale Doctrine, which is achievable through immutable ownership. Embodiments also provide a buyback option as an alternative to Digital Millennium Copyright Act (DMCA) takedowns.

Furthermore, with anti-piracy measures and a unique approach to content buyback requests, embodiments ensure fair and comprehensive protection for IP owners. Embodiments provide applications that extend beyond traditional digital media, encompassing physical goods authentication, gaming and metaverse interoperability, and the distribution of digital tools and software. Embodiments are well-positioned to integrate with emerging technologies and set new standards within the evolving digital landscape.

The following are definitions of terms used herein.

AES-256-GCM: An encryption standard known for its speed and security, used widely for securing sensitive data.

API (Application Programming Interface): A set of rules and protocols for building and interacting with software applications. It defines the way different software entities should interact with each other.

Blobs: Large chunks of data stored in a cost-effective and scalable manner, enhancing data availability, as well as reducing storage and transactional costs on the Ethereum blockchain.

Blockchain: A decentralized digital ledger that records transactions across multiple computers in a way that the recorded transactions cannot be altered retroactively.

Cross-chain Bridges: Technologies that enable interoperability between different blockchain networks, allowing for the transfer of assets and data across chains.

Cryptocurrency: A type of digital or virtual currency that uses cryptography for security and operates independently of a central bank. It is the medium of exchange within blockchain networks.

Distributed Hash Table (DHT): A decentralized data structure that provides efficient lookup and data distribution across a network.

Ethereum Virtual Machine (EVM): A computation engine that acts as a decentralized virtual machine, executing smart contracts on the Ethereum blockchain.

First Sale Doctrine: A legal principle that allows the purchaser of a physical copy of a copyrighted work to resell it, lend it, or otherwise dispose of it as they see fit without requiring permission from the copyright holder.

Hardware Security Module (HSM): A physical computing device that safeguards and manages digital keys, performs encryption and decryption functions for digital signatures, and provides strong authentication to access critical keys for server applications.

InterPlanetary File System (IPFS): A protocol and peer-to-peer network for storing and sharing data in a distributed file system. IPFS uses content-addressing to uniquely identify each file in a global namespace connecting all computing devices.

Key Derivation Function (KDF): A cryptographic algorithm that derives one or more secret keys from a secret value such as a master key, a password, or a passphrase.

Key Sharding: The process of splitting a cryptographic key into multiple parts and distributing them across different nodes or locations to enhance security and prevent unauthorized access.

NFT (Non-Fungible Token): A type of cryptographic token on a blockchain that represents a unique asset or item.

Quantum-Resistant Encryption: Type of encryption designed to be secure against the potential threat posed by quantum computers, which can break many of the current cryptographic algorithms.

Secure Enclaves or Trusted Execution Environments (TEEs): Protected areas within a processor that provide security features such as isolated execution and integrity checking to increase the security of data and applications.

Sharding: A technique used in blockchain systems to partition the network into smaller, more manageable parts called shards, which can process transactions in parallel, improving scalability.

Smart Contract: Self-executing contracts with the terms of the agreement directly written into lines of code.

Wallet (Digital/Crypto Wallet): A digital wallet that allows users to store and manage their digital currencies and assets. It contains pairs of private and public cryptographic keys.

XChaCha20-Poly1305: A combination of stream cipher and authentication code providing high levels of security and is often used in encrypted communications.

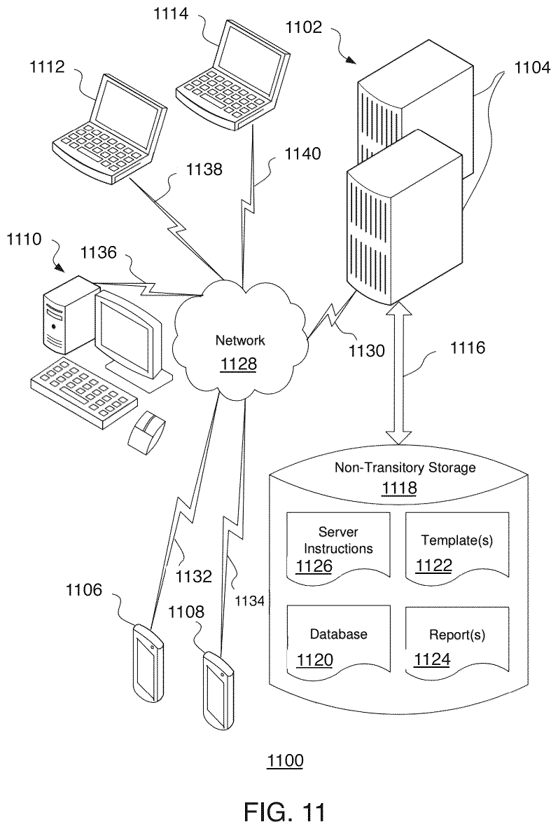

FIG. 11 is a block diagram of an example network environment 1100 of the present disclosure. In various embodiments, a server system 1102 may include one or more server computing systems 1104 arranged in a cluster or “server farm” arrangement. In various embodiments, the server system 1102 may be used to implement the system 102 of FIG. 1, as well as to perform embodiments described herein.

The server system 1102 services users of various nonportable and portable computing systems 1106, 1108, 1110, 1112, and 1114. The particular types of computing systems may vary, depending on the particular implementation. In this example embodiment, the computing systems 1106, 1108, 1110, 1112, and 1114 include smartphones (or tablets) 1106 and 1108, a desktop computer 1110, and laptop or notebook computers 1112 and 1114. The computing systems 1106, 1108, 1110, 1112, and 1114 access data maintained at a server system 1102.

The designation “computing system” is used to generally encompass any device capable of processing instructions and accessing the server system 1102 to provide or retrieve data. A computing system as described herein is not intended to suggest any particular type of computer or other device. The computing systems 1106, 1108, 1110, 1112, and 1114 are shown for example and illustration and are not intended to be limiting. While some descriptions herein may refer to devices used by users at sites as “smartphones,” it will be appreciated that any portable device with a display and communications capabilities, such as tablets or tablet phones or other computing systems may be used in various embodiments. An example general architecture and structure of the computing systems 1106, 1108, 1110, 1112, and 1114 are described below with reference to FIG. 11.

In various embodiments, the server computing systems 1104 are coupled to a high-speed channel or bus 1116 and to a non-transitory storage 1118 that the server computing systems 1104 share or that is duplicated for each of the server computing systems 1104. The non-transitory storage 1118 may include direct access hard disk devices, solid-state memory devices, or another storage technology. In various embodiments, the non-transitory storage 1118 includes operating system software and other utilities used to operate the server computing systems 1104 and may also include a database 1120, templates 1122, storage for reports 1124, and server instructions 1126 for operating and managing access to the database 1120, templates 1122, and reports 1124.

In various embodiments, the server system 1102 is coupled to a network 1128, which may include the Internet or another computer network, via a network connection 1130 (such as a high-speed connection) to provide sufficient bandwidth to support multiple users accessing the server system 1102 with minimal latency. The computing systems 1106, 1108, 1110, 1112, and 1114 connect to the network 1128 via communications links 1132, 1134, 1136, 1138, and 1140, respectively. The communications links 1132, 1134, 1136, 1138, and 1140 may include a wireless data communications link such as provided by cellular-type communications network or a Wi-Fi network that enables communication with the network 1128. Other means of wireless communications, such as Bluetooth communications or other means of wireless communication may be used. In addition, although not commonly used with handheld computing systems 1106 and 1108, the communications links 1132, 1134, 1136, 1138, and 1140 also may include wired network connections, such as Ethernet connections. In the case of a handheld-computing systems 1106 and 1108 or another portable computing device such as laptop or notebook computing systems 1112 and 1114, Ethernet connections may be provided through a docking station (not shown). The communications links 1132, 1134, 1136, 1138, and 1140 may be continuous or switchable links that provide continual access to the network 1128 or selective, as-desired access to the network 1128, respectively.

It will also be appreciated that the server system 1102 and the network 1128 may be operated by a third-party provider, such as a commercial web services provider. The various embodiments described do not depend on any particular type of hardware or ownership of the hardware used to support the networked system herein described. In various embodiments, network environment 1100 may not have all of the components shown and/or may have other elements including other types of components instead of, or in addition to, those shown herein.

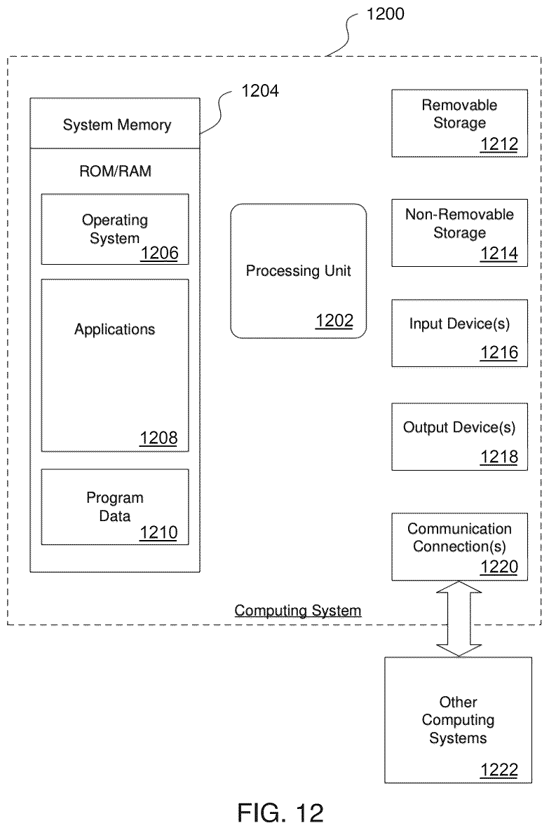

FIG. 12 is a block diagram of an example computing system 1200 of the present disclosure. In various embodiments, the computing system 1200 may be used to implement the system 102 of FIG. 1 and/or server system 1102 of FIG. 11, and/or other computers and servers of FIG. 11, as well as to perform embodiments described herein.

The computing system 1200 typically includes at least one processing unit 1202 and a system memory 1204. Depending on the particular configuration and type of computing device, the system memory 1404 may be volatile such as random-access memory (RAM), non-volatile such as read-only memory (ROM), flash memory, and the like, or some combination of volatile memory and non-volatile memory. The system memory 1204 typically maintains an operating system 1206, one or more applications 1208, and program data 1210. The operating system 1206 may include any number of operating systems executable on desktops or portable devices including, but not limited to, Linux, Microsoft Windows®, Apple OS®, or Android®.

The computing system 1200 may also have additional features or functionality. For example, the computing system 1200 may also include additional data storage devices (removable and/or non-removable) such as, for example, magnetic disks, optical disks, tape, or flash memory. Such additional storage may include a removable storage 1212 and a non-removable storage 1214. Computer storage media may include volatile and non-volatile, removable and non-removable media implemented in any method or technology for storage of information, such as computer-readable instructions, data structures, program modules or other data. The system memory 1204, the removable storage 1212, and the non-removable storage 1214 are all examples of computer storage media. Available types of computer storage media include, but are not limited to, RAM, ROM, EEPROM, flash memory (in both removable and non-removable forms) or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing system 1200. Any such computer storage media may be part of the computing system 1200.

The computing system 1200 may also have input device(s) 1216 such as a keyboard, mouse, pen, voice input device, touchscreen input device, etc. Output device(s) 1218 such as a display, speakers, printer, short-range transceivers such as a Bluetooth transceiver, etc., may also be included. The computing system 1200 also may include one or more communication connections 1220 that allow the computing system 1200 to communicate with other computing systems 1222, such as over a wired or wireless network or via Bluetooth (a Bluetooth transceiver may be regarded as an input/output device and a communications connection). The one or more communication connections 1220 are an example of communication media. Available forms of communication media typically carry computer-readable instructions, data structures, program modules or other data in a modulated data signal such as a carrier wave or other transport mechanism and include any information delivery media. The term “modulated data signal” may include a signal that has one or more of its characteristics set or changed in such a manner as to encode information in the signal. By way of illustrative example only and not of limitation, communication media may include wired media such as a wired network or direct-wired connection, and wireless media such as acoustic, radio frequency (RF), infrared and other wireless media. The term computer-readable media as used herein includes both storage media and communication media.

In various embodiments, computing system 1200 may not have all of the components shown and/or may have other elements including other types of components instead of, or in addition to, those shown herein.

All dimensions specified in this disclosure are by way of example only and are not intended to be limiting. Further, the proportions shown in the figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the disclosure have been described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising,” “comprises” and “comprised” are not intended to exclude other additives, components, integers or steps.

In the description herein, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems, methods and computer programs according to various embodiments disclosed. In this regard, each block in the flowchart or block diagrams can represent a module, segment, or portion of code, that can comprise one or more executable instructions for implementing the specified logical function(s). It should also be noted that, in some alternative implementations, the functions noted in the blocks may occur out of the order noted in the figures. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine-readable mediums for storing information. The term “machine-readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

Although the present disclosure is illustrated and described herein with reference to illustrative embodiments and specific examples provided, it will be readily apparent to those of ordinary skill in the art that other embodiments and examples may perform similar functions and/or achieve like results. All such equivalent embodiments and examples are within the spirit and scope of the present disclosure and are intended to be covered by the following non-limiting claims for all purposes.

What is claimed is:

1. A system comprising:
one or more processors; and
logic encoded in one or more non-transitory computer-readable storage media for execution by the one or more processors and when executed operable to cause the one or more processors to perform operations comprising:
managing, by a first node, digital content and metadata associated with the digital content, wherein the digital content is decentralized;
enabling, by a second node, access to the digital content by an authorized user, wherein the authorized user purchased the digital content; and
managing, by a third node, cryptographic keys that are used to encrypt and decrypt the digital content.

2. The system of claim 1, wherein the logic when executed is further operable to cause the one or more processors to perform operations comprising:
chunking the digital content by the third node;
encrypting the chunked digital content by the third node; and
scattering the chunked and encrypted digital content via the first node.

3. The system of claim 1, wherein ownership of the digital content is immutable via the system replicating physical media ownership through the integration of digital content rights in the digital content by use of immutable tokens that remove revocation or alteration.

4. The system of claim 1, wherein the logic when executed is further operable to cause the one or more processors to perform operations comprising enabling the digital content to be temporarily transferred from the authorized user to a temporary user.

5. The system of claim 1, wherein the logic when executed is further operable to cause the one or more processors to perform operations comprising securing communication among the first node, the second node, and the third node.

6. The system of claim 1, wherein the logic when executed is further operable to cause the one or more processors to perform operations comprising coupling physical goods with digital non-fungible tokens using tamper-evident near-field communication tags.

7. The system of claim 1, wherein one or more master encryption keys are derived from secret inputs, and wherein the one or more master encryption key decrypts one or more cryptographic keys.

8. A computer-implemented method comprising:
managing, by a first node, digital content and metadata associated with the digital content, wherein the digital content is decentralized;
enabling, by a second node, access to the digital content by an authorized user, wherein the authorized user purchased the digital content; and
managing, by a third node, cryptographic keys that are used to encrypt and decrypt the digital content.

9. The method of claim 8, further comprising:
chunking the digital content by the third node;
encrypting the chunked digital content by the third node; and
scattering the chunked and encrypted digital content via the first node.

10. The method of claim 8, wherein ownership of the digital content is immutable via the system replicating physical media ownership through the integration of digital content rights in the digital content by use of immutable tokens that remove revocation or alteration.

11. The method of claim 8, further comprising enabling the digital content to be temporarily transferred from the authorized user to a temporary user.

12. The method of claim 8, further comprising securing communication among the first node, the second node, and the third node.

13. The method of claim 8, further comprising coupling physical goods with digital non-fungible tokens using tamper-evident near-field communication tags.

14. The method of claim 8, wherein one or more master encryption keys are derived from secret inputs, and wherein the one or more master encryption key decrypts one or more cryptographic keys.

15. A non-transitory computer-readable storage medium with program instructions stored thereon, the program instructions when executed by one or more processors are operable to cause the one or more processors to perform operations comprising:
managing, by a first node, digital content and metadata associated with the digital content, wherein the digital content is decentralized;
enabling, by a second node, access to the digital content by an authorized user, wherein the authorized user purchased the digital content; and
managing, by a third node, cryptographic keys that are used to encrypt and decrypt the digital content.

16. The computer-readable storage medium of claim 15, wherein the instructions when executed are further operable to cause the one or more processors to perform operations comprising:
chunking the digital content by the third node;
encrypting the chunked digital content by the third node; and
scattering the chunked and encrypted digital content via the first node.

17. The computer-readable storage medium of claim 15, wherein ownership of the digital content is immutable via the system replicating physical media ownership through the integration of digital content rights in the digital content by use of immutable tokens that remove revocation or alteration.

18. The computer-readable storage medium of claim 15, wherein the instructions when executed are further operable to cause the one or more processors to perform operations comprising enabling the digital content to be temporarily transferred from the authorized user to a temporary user.

19. The computer-readable storage medium of claim 15, wherein the instructions when executed are further operable to cause the one or more processors to perform operations comprising securing communication among the first node, the second node, and the third node.

20. The computer-readable storage medium of claim 15, wherein the instructions when executed are further operable to cause the one or more processors to perform operations comprising coupling physical goods with digital non-fungible tokens using tamper-evident near-field communication tags.

21. A computer-implemented method comprising:
providing a decentralized platform for storage, management, and distribution of digital content, wherein the decentralized platform is accessible through a user interface;
receiving the digital content at the decentralized platform from a rights holder or a content creator for distribution on the decentralized platform;
enabling a user to engage with the decentralized platform through the user interface via a purchase, a sale, a transfer, a rental, or an access associated with the digital content, each transfer transaction being facilitated by a digital token or a fiat currency processed through a third-party payment gateway;
charging a transaction fee for each transfer transaction facilitated by the digital token or the fiat currency processed through the third-party payment gateway; and
providing a buyback mechanism on the decentralized platform where the user can transfer the digital content back to the decentralized platform or to another user, with a buyback fee applied to a buyback transaction, the buyback fee being facilitated by the digital token or the fiat currency processed through the third-party payment gateway.
